(19) United States
(12) Patent Application Publication
(10) Pub. No.: US 2011/0231670 A1
(43) Pub. Date: Sep. 22, 2011

(54) SECURE ACCESS DEVICE FOR CLOUD COMPUTING

(76) Inventors: Oleksiy Yu. SHEVCHENKO, Broadlands, VA (US); Alexander V. Pyntikov, Ashburn, VA (US)

(21) Appl. No.: 12/724,801

(22) Filed: Mar. 16, 2010

(51) Int. Cl. G06F 21/20; G06F 12/14; G06F 15/173

(52) U.S. Cl. 713/189; 709/225; 709/226

(57) ABSTRACT

A secure access device for providing secure access of a computing resources (CR) user, such as a cloud user, to remote computing resources offered by multiple CR providers, such as cloud providers. The device has a network interface circuit for providing interface to a data network configured for accessing the remote computing resources offered by the multiple CR providers. A network access controller is configured to interact with the network interface for controlling access of the CR user to the remote computing resources. Multiple data storage sections may be provided. Each of them keeps computing environment data (CED) associated with a particular CR provider. The CED define a secure local computing environment prescribed by the CR provider for accessing the remote computing resources offered by this CR provider. The network access controller enables the CR provider to manage the CED and prevents the CED from being modified even by the CR user.

### TECHNICAL FIELD

This disclosure relates to computer systems, and more particularly, to devices and methods for controlling user's access to providers of remote computing resources, such as cloud providers that offer cloud infrastructures for cloud computing. For example, the present disclosure is applicable to providing secure user's access to remote medical services and information offered by cloud providers of medical services and information.

### BACKGROUND ART

Cloud computing is a new way of delivering computing resources that enables users to access computing resources provided at remote servers. For example, medical cloud computing services can provide cloud infrastructures for storage of medical records and medical imaging data in a form accessible for doctors and patients. The cloud infrastructures also can provide users with remote access to various medical tools and applications, such as a medication scheduler, a heart attack risk calculator, etc. By using cloud infrastructures, users can avoid capital expenditure on hardware, software, and information technology services. Cloud users pay a cloud provider only for what they use. Consumption is usually billed on a utility or subscription basis with little or no upfront cost. Other benefits of this time sharing-style approach are low barriers to entry, shared infrastructure and costs, low management overhead, and immediate access to a broad range of applications.

The cloud computing, however, comes with real dangers for cloud users as well as cloud providers. While using cloud infrastructures, the cloud user necessarily cedes control to the cloud provider on a number of security issues. In particular, with cloud computing, user's confidential data are processed by the cloud provider outside the user's premises. Therefore, the cloud provider must offer a commitment to provide reliable security services. However, the security measures that the cloud provider can offer are limited because the cloud provider does not have control over the cloud user's computer device used for accessing the cloud. Computing resources offered by the cloud provider can be compromised if a hacker gets access to a computer of a cloud user that have valid rights to access the cloud provider's resources.

On the other side, the cloud user has good reasons to be concerned that user's data stored by the cloud provider will be compromised if an unauthorized party gets access to remote computer resources allocated to the cloud user by the cloud provider. For example, users of cloud medical systems are concerned that their medical records can be accessed by unauthorized parties.

Therefore, it would be desirable to develop a cloud access device that would address security concerns of cloud providers as well as cloud users.

### SUMMARY OF THE DISCLOSURE

To address security concerns of cloud providers as well as cloud users, the present disclosure offers a secure access device and a secure access method that implement a concept of a “double lock safe deposit box” scheme. This scheme includes two layers of protection for cloud user's resources maintained by the cloud provider. The first layer of protection involves the first “lock” controlled by the cloud provider so as to enable the cloud provider to have full control over the contents of a device used by the cloud user for accessing the cloud. The second layer of protection involves the second “lock” controlled by the cloud user so as to enable the cloud user to have full control over the access to the cloud user's data and resources maintained by the cloud provider.

In accordance with one aspect of the disclosure, a secure access device for providing secure access of a computing resources (CR) user, such as a cloud user, to remote computing resources offered by multiple CR providers, such as cloud providers, comprises a network interface circuit for providing interface to a data network configured for accessing the remote computing resources offered by the multiple CR providers. A network access controller of the secure access device may interact with the network interface circuit for controlling access of the CR user to the remote computing resources. Multiple data storage sections may be arranged in the secure access device. Each section keeps computing environment data (CED) associated with a particular CR provider. The CED define a secure local computing environment prescribed by the CR provider for accessing the remote computing resources offered by this CR provider. The network access controller enables the CR provider to manage the CED and prevents the CED from being modified even by the CR user.

For example, the secure access device of the present disclosure may be configured to provide secure access to medical data maintained by remote medical information providers.

In accordance with another aspect of the disclosure, the network access controller may be further configured for preventing an unauthorized party from accessing remote computing resources associated with the CR user.

In particular, the secure access device may comprise a security controller for controlling the network controller so as to enable the CR user to access the remote computing resources and to prevent an unauthorized party from accessing the remote computing resources associated with the CR user.

The security controller may be configured to encrypt data of the CR user stored at a remote storage of a CR provider.

In accordance with a further aspect of the disclosure, the CR provider may control the network access controller to allow the CR user to access the CR provider's remote computing resources only in a manner prescribed by the CR provider, for example, using a secure network connection.

Also, the network access controller may be controlled to prevent a data processing unit from producing the local computing environment without authorization of the CR provider. The CR provider may control the network access controller to allow a data processing unit to run the CED so as to produce the local computing environment.

Further, the CR provider may control the network access controller to prevent an unauthorized user of the secure access device from accessing the computing resources offered by the CR provider.

In accordance with an exemplary embodiment, an internal data processing unit of the secure access device may receive the CED to produce the prescribed local computing environment. The CR provider may control the network access controller to provide transfer of the CED to the internal data processing unit. A buffer memory may be configured for preloading the CED from the data storage section while the network access controller obtains the CR provider's authorization to transfer the CED for producing the local computing environment.

In accordance with a further aspect of the disclosure, a data flow control circuit may be configured for selectively transferring the CED to the internal data processing unit or to a computer device externally coupled to the secure access device. The data flow control circuit may prevent the external computer device from receiving the CED when the internal data processing unit is selected for producing the prescribed local computing environment. Also, the secure access device is prevented from receiving any input signal from the external computer device.

In accordance with an additional aspect of the disclosure, an input device controller of the secure access device may receive an input signal from an input device used by the CR user. The input device controller may forward the input signal to the internal data processing unit when the CED is transferred to the internal data processing unit, or to the external computer device when the CED is transferred to the external computer device. The input device controller is controlled to prevent the input signal from being forwarded to the external computer device, when the CED is transferred to the internal data processing unit. Also, the input device controller may be controlled to prevent the input signal from being forwarded to the external computer device when the CR user enters sensitive information using the input device.

In accordance with a further aspect of the invention, the secure access device may include an operating memory for storing data and software resources when the CR user operates with remote resources of a CR provider. The CED may include a hibernate file for restoring content of the operating memory to a state that existed before the CR user terminated previous access to the resources of the CR provider.

Also, a snapshot of content of the operating memory may be created when the CR user terminates access to resources of a first CR provider. The snapshot may be stored in the secure access device so as to enable the CR user to operate with the resources of the first CR provider while the CR user operates with resources of a second CR provider.

In accordance with a method of the present disclosure, the following steps are carried out to enable a CR user to access remote computing resources offered by multiple CR providers over a data network:
enabling multiple CR providers to manage access data in an access device available for the CR user, the access data being provided to enable the CR user to access the remote computing resources over the data network,
maintaining the access data in the access device so as to prevent the CR user from modifying the access data, and
enabling the CR user to prevent an authorized party from accessing the remote computing resources associated with the CR user.

Based on the access data, a local computing environment may be produced for accessing the remote computing resources. The CR user may be enabled to select between producing the local computing environment in the access device, and producing the local computing environment in an external computer device.

The external computer device may be prevented from receiving the access data from the access device when the local computing environment is produced in the access device.

Also, the external computer device may be prevented from receiving an input signal from an input device used by the CR user when the local computing environment is produced in the access device.

Further, the external computer device may be prevented from receiving an input signal from an input device used by the CR user when the CR user enters sensitive information using the input device.

Additional advantages and aspects of the disclosure will become readily apparent to those skilled in the art from the following detailed description, wherein embodiments of the present disclosure are shown and described, simply by way of illustration of the best mode contemplated for practicing the present disclosure. As will be described, the disclosure is capable of other and different embodiments, and its several details are susceptible of modification in various obvious respects, all without departing from the spirit of the disclosure. Accordingly, the drawings and description are to be regarded as illustrative in nature, and not as limitative.

### BRIEF DESCRIPTION OF THE DRAWINGS

The drawing figures depict concepts by way of example, not by way of limitations. In the figures, like reference numerals refer to the same or similar elements.

FIG. 1 is a diagram illustrating a general concept of accessing remote computing resources of multiple cloud providers using a cloud secure access device of the present disclosure.

FIG. 2 is a diagram illustrating an exemplary embodiment of the cloud secure access device.

### DETAILED DISCLOSURE OF THE EMBODIMENTS

The present disclosure will be made with an example of a cloud access device for providing secure access to cloud computing infrastructures. It will become apparent, however, that the concepts described herein are applicable to providing user's access to any computing resources via any communication link. For example, the cloud access device of the present disclosure may be used for grid computing systems or cluster computing systems.

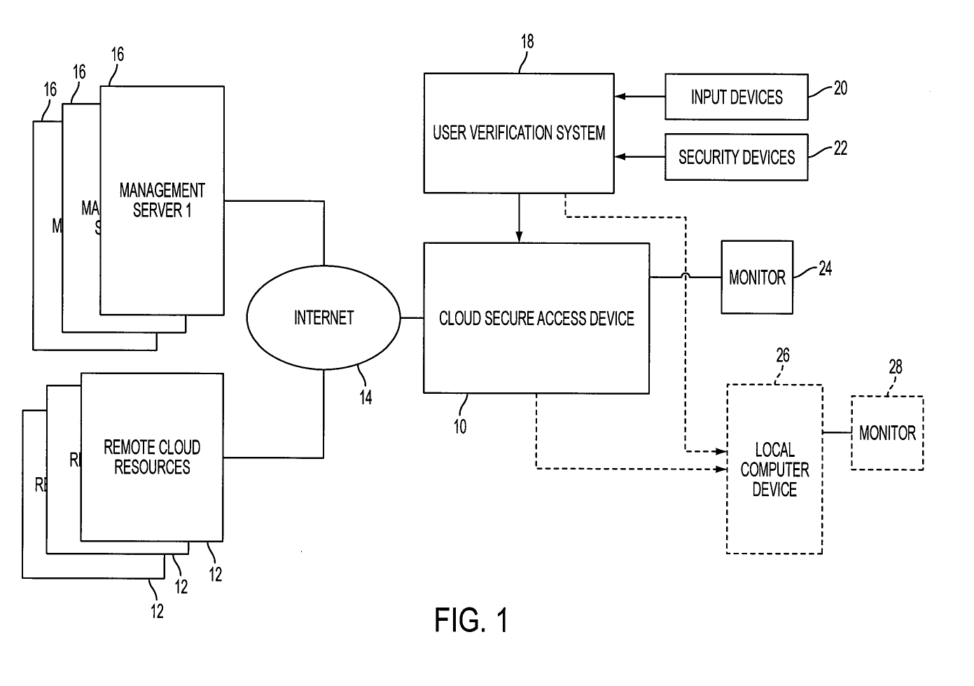

FIG. 1 illustrates a general concept of providing secure access to cloud computing resources in accordance with the present disclosure. A Cloud Secure Access (CSA) device 10 of the present disclosure enables a cloud user to access remote cloud computing resources 12 provided by multiple cloud providers. The cloud computing resources 12 may include various data maintained at cloud providers' data storage facilities, and software applications that can be run at cloud providers' servers per requests of cloud users. For example, the CSA device 10 may be configured to access remote cloud computing resources of cloud medical systems that include medical records, medical imaging data and various medical tools and applications accessible to patients and doctors. The remote cloud computing resources 12 may be accessible over a private or public data network 14, for example, over the Internet.

The CSA device 10 implements a concept of a “double lock safe deposit box” scheme of the present disclosure. This scheme includes two layers of protection for cloud user's resources maintained by the cloud provider. The first layer of protection involves the first “lock” controlled by the cloud provider so as to enable the cloud provider to have full control over the contents of a device used by the cloud user for accessing the cloud. The second layer of protection involves the second “lock” controlled by the cloud user so as to enable the cloud user to have full control over the access to the cloud user's data and resources maintained by the cloud provider.

To support cloud providers' control over the contents of the CSA device 10, cloud infrastructures of cloud providers may include management servers 16 arranged for managing users' access to the cloud computing resources 12. For example, the cloud architecture in FIG. 1 involves multiple cloud providers, each of which has at least one management server 16 for managing access of a cloud user to the cloud computing resources 12 offered by the respective cloud provider. The management server 16 of a particular cloud provider may perform various management functions associated with access by the CSA device 10 to the cloud of this cloud provider, such as establishing and enforcing security policies for accessing the cloud computing resources by various categories of cloud users.

As discussed in more detail below, to support access to cloud resources offered by multiple cloud providers, the CSA device 10 may store computing environment data (CED) associated with each cloud provider. The cloud provider's CED are selected to create a secure local computing environment prescribed by a particular cloud provider for operating with the cloud resources offered by this cloud provider. The CED of each cloud provider may include an operating system served as a host for computing applications run on the CSA device, thin and/or thick client software applications required to operate with cloud provider's resources, specific software tools, plug-ins and programs customized for operating with cloud provider's resource, etc. Also, the CED may include access control data that define security policies with respect to particular cloud users. For example, the CED may define which computing resources of the cloud provider are permitted to be accessed by particular cloud users.

The management server 16 of a particular cloud provider may load the CED of this cloud provider to the CSA device 10 over the data network 14. Alternatively, the cloud user may be enabled to load the CED to the CSA device 10 from a read-only medium provided by the cloud provider. Thereafter, the management server 16 may monitor the cloud provider's CED in the CSA device 10 and perform required updates to make sure that the CSA device 10 does not have security holes that allow unauthorized users to gain access to the cloud infrastructure of the particular cloud provider. The management server 16 may prevent the CSA device 10 from accessing the cloud if the CSA device 10 does not meet the cloud provider's requirements.

The CSA device 10 is configured to physically isolate CED of each cloud provider from the CED of the other cloud providers, and to create a local computing environment for operating with cloud resources of each cloud provider, physically isolated from local computing environments created for the other cloud providers. The CSA device 10 enables each cloud provider to fully control the CED associated with the respective cloud provider, so as to prevent any malware, such as computer viruses, worms, trojan horses, spyware, adware, crimeware, etc. from being provided in the CSA device 10. Moreover, the CSA device 10 is configured to prevent the CED maintained in the CSA device 10 from being modified so as to prevent any malware from being planted into the CSA device 10. As discussed below, the configuration of the CSA device 10 does not enable even an authorized user of the CSA device 10 to modify the CED.

In accordance with an exemplary embodiment of the disclosure, the CED may include a hibernate file created for a particular cloud provider before the CSA device 10 terminates operations with resources of that cloud provider. The hibernate file enables the CSA device 10 to restore the content of its memory to the state that existed when hibernation was invoked. As a result, the CSA device 10 may accelerate access to resources of a particular cloud provider.

To support cloud user's control over the access to the cloud user's data and resources maintained by the cloud provider, the CSA device 10 interacts with a user verification system 18 that enables a cloud user to authorize access to the cloud resources. To more clearly describe the general concept of the present disclosure, the user verification system 18 is shown separately from the CSA device 10. However, functions of the user verification system 18 described below may be performed by various elements of the CSA device 10. In particular, the user verification system 18 may enable a user to supply the CSA device 10 with inputs from external input devices 20, such as a keyboard or a mouse, to enter verification information, such as a user name and a password, so as to authorize access of the user to the CSA device 10 and/or to the remote computing resources of a particular cloud provider. Also, the user verification system 18 may provide the CSA device 10 with inputs from security devices 22, such as a token, smart card, fingerprint reader, to authenticate the user. For example, the user verification system 18 may utilize Public Key Infrastructure (PKI) techniques.

The user verification system 18 may enable the cloud user to utilize a CSA device 10 shared with other cloud users. For example, a patient may authorize the CSA device 10 shared at a doctor's office with other patients to access medical information of this patient maintained by a cloud provider.

As discussed below, the CSA device 10 may be configured as an autonomous hardware device to enable a cloud user to operate with the cloud computing resources without additional computer devices. A monitor 24 may be provided to output information from the CSA device 10.

Alternatively, the CSA device 10 may be configured as a hardware attachment to a local computer device 26, such as a laptop or desktop computer, to enable the cloud user to utilize resources of the local computer device during cloud computing operations. The CSA device 10 may have a local output connectable to the local computer device 26 via any wired or wireless link. Security arrangements provided in the CSA device 10 enable a cloud user to access cloud resources using either a private computer device of the user, or a public computer device shared by multiple users, such as a computer available in a doctor's office. A monitor 28 may be provided to output information from the local computer device 26.

To prevent contamination of the CSA device 10 from malware that may be planted in the local computer device 26, the CSA device 10 does not have any input connectable to the local computer device 26. Therefore, the CSA device 10 is prevented from receiving any signal from the local computer device 26 even when the CSA device 10 is linked to the local computer device 26.

When the CSA device 10 operates as an attachment to the local computer device 26, the same input devices 20 and/or security devices 22 may be used for operating the CSA device 10 and the local computer device 26. The user verification system 18 may include an input switch that switches the input devices 20 and/or security devices 22 between the CSA device 10 and the local computing device 26. When the user enters sensitive information for accessing the cloud resources, for example, during user authorization and/or authentication, the input switch may be controlled to connect the input devices 20 and/or security devices 22 to the CSA device 10 and to prevent the local computer device 26 from receiving any input signal from the input devices 20 and/or security devices 22. As a result, even if keylogging malware is planted in the local computer device 26 to monitor user's information entered via the input devices 20 and/or security devices 22, the keylogger is not able to detect user's sensitive information.

Also, the input switch may prevent the local computer device 26 from receiving any input signal from the input devices 20 and/or security devices 22 when the user operates with the cloud resources using the CSA device 10. When the user needs access to the local computer device 26, the input switch is controlled to connect the input devices 20 and/or security devices 22 to the local computer device 26 and prevent the CSA device 10 from receiving any input signal from the input devices 20 and/or security devices 22. This feature prevents the CSA device 10 from being contaminated via the input devices 20 and/or security devices 22 when the user operates with the local computer device 26.

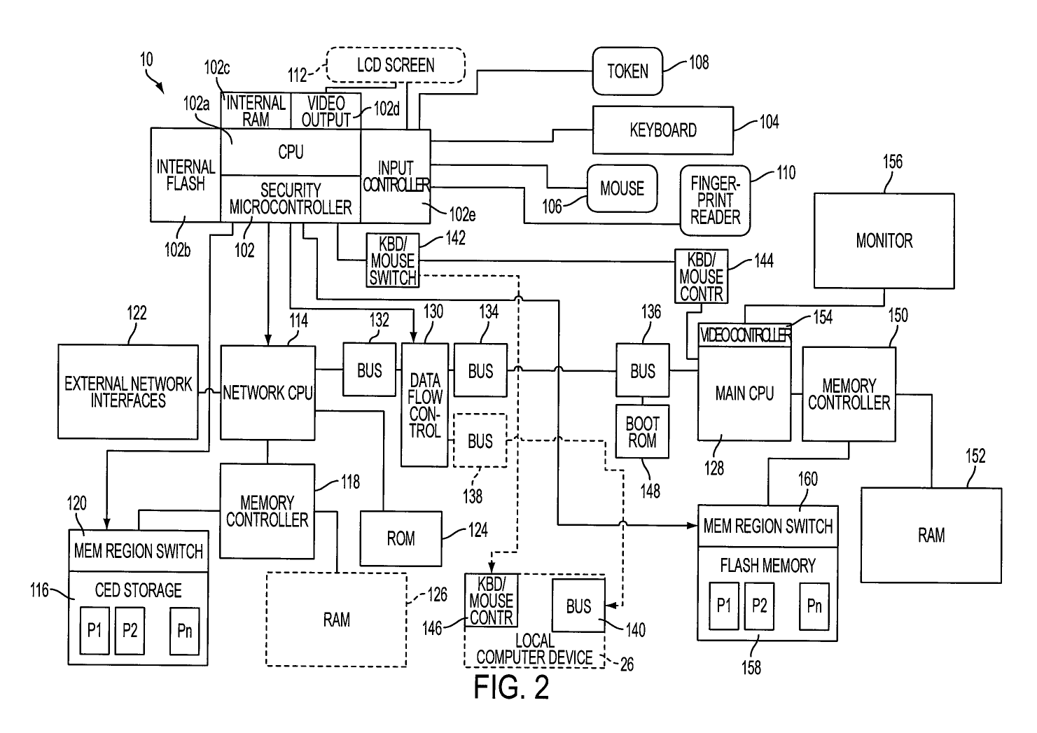

FIG. 2 illustrates an exemplary embodiment of the CSA device 10 of the present disclosure configured for providing a cloud user with secure access to remote computing resources 12 of multiple cloud providers. The CSA device 10 may include a security microcontroller 102 configured for enabling a cloud user to select one cloud provider among multiple available cloud providers and to access the remote computing resources offered by the selected cloud provider. Although the present disclosure describes that the CSA device 10 is configured for accessing computing resources of multiple cloud providers, one skilled in the art would realize that the CSA device 10 may be used for accessing computing resources of a single cloud provider.

The security microcontroller 102 may comprise a central processing unit (CPU) 102a interacting with an internal flash memory 102b, an internal random access memory (RAM) 102c, a video output controller 102d and an input controller 102e. The elements of the security microcontroller 102 may be arranged on the same chip or may be provided as separate components. Via the input controller 102e, the security microcontroller 102 may be coupled to desired input devices such as a keyboard 104 and a mouse 106, and to desired security devices for user authentication, such as a token 108 and a fingerprint reader 110. The input controller 102e may be configured for supporting any desired wired or wireless link selected for connection of the input and security devices. The security microcontroller 102 may perform user verification and authentication operations to make sure that only an authorized user has access to the CSA device 10 and/or to remote computing resources offered by a particular cloud provider.

Also, the security microcontroller 102 may perform encryption of cloud user's data stored by cloud providers at remote storage facilities. For example, the security microcontroller 102 may interact with a cloud user to generate unique cryptographic keys for encrypting user's data stored by the cloud provider. The cryptographic keys may be stored in the internal flash memory 102b.

The security microcontroller 102 may interact with a display device 112, such as a liquid crystal display (LCD) screen, configured to provide a graphical user interface (GUI) for enabling a cloud user to operate the CSA device 10. The GUI may be used to interact with the cloud user during user verification and authentication operations. When a person is recognized as an authorized user of the CSA device 10, the GUI may display a menu that lists cloud providers and/or remote computing resources that may be accessed by the cloud user using the CSA device 10. The cloud user may select a desired cloud provider by supplying the CSA device 10 with a provider selection command entered using the touch screen or a desired input device.

In response to the provider selection command, the security microcontroller 102 controls a network CPU 114 to perform access to the selected cloud provider. In response, to this command, the network CPU 114 may access the management server 16 of the selected cloud provider to verify that the cloud user is allowed to access the computing resources of this cloud provider. The management server 16 may check the verification information entered by a user to determine user's access rights. Also, the management server 16 may compare user's authentication information obtained by the security microprocessor 102 with the respective information kept by the cloud provider.

If the selected cloud provider allows the user to access the cloud provider's computing resources, the network CPU 114 may access the management server 16 of the selected cloud provider to obtain data required for access or to update existing data maintained in the CSA device 10. In particular, the CSA device 10 may include a computing environment data (CED) storage device 116, such as a flash memory device, coupled via a memory controller 118 to the network CPU 114. The CED storage device 116 may be split into multiple CED memory partitions p1, p2, . . . , pn, each of which is configured for storing CED associated with one cloud provider so as to physically isolate CED of one cloud provider from the CEDs of the other cloud providers. As a result, the CED of one cloud provider can not be compromised by malicious data of another cloud provider.

The CED of a particular cloud provider is selected to create a secure local computing environment prescribed by this cloud provider for operating with the remote cloud resources 12 offered by the cloud provider. The CED of each cloud provider may include an operating system served as a host for computing applications run on the CSA device 10, thin and/or thick client software applications required to operate with cloud provider's resources, software tools, plug-ins and programs customized for operating with cloud provider's resources, etc. Also, the CED may include access control data that define cloud provider's security policies with respect to particular cloud users. For example, the CED may define which computing resources of the cloud provider are permitted to be accessed by particular cloud users. The cloud provider's CED may be loaded into the respective memory partition from the management server 16 of a particular cloud provider or may be pre-loaded by a cloud user from a read-only memory (ROM) medium, such as CD-ROM or DVD-ROM, provided by the cloud provider.

Also, the CED stored in a CED memory partition of the CED storage device 116 may include a hibernate file created for a particular cloud provider before the CSA device 10 terminates operations with resources of that cloud provider. The CED hibernate file enables the CSA device 10 to restore the content of its random-access memory to the state that existed when hibernation was invoked. As a result, the CSA device 10 may accelerate access to resources of a particular cloud provider.

When the network CPU 114 receives an instruction from the security microcontroller 102 to access a selected cloud provider, the security microcontroller 102 may also control a memory region switch 120 of the CED storage device 116 to enable access to the partition associated with the selected cloud provider. In response to the cloud provider access instruction, the network CPU 114 via an external network interface 122 sends a verification request to the management server 16 of the selected cloud provider in order to determine whether the CED associated with the selected cloud provider stored in the respective partition of the CED storage device 116 corresponds to the most recent security policies and updates of the selected cloud provider. The external network interface 122 may be configured to support connection of the CSA device 10 to the data network 14 via any desired wired or wireless communication link. The network CPU 114 may be configured to support a virtual private network (VPN) connection and to provide firewall functions. A read-only memory (ROM) 124 may store data and firmware for supporting operation of the network CPU 114. To expedite cloud provider access operations, a random access memory (RAM) 126 may be optionally provided for pre-fetching the CED from the CED storage device 116 to the RAM 126 while the network CPU 114 interacts with the remote management server 122 to perform CED verification.

If the management server 16 of the selected cloud provider determines that the CED does not correspond to the most recent requirements of the respective cloud provider, the management server 16 interacts with the network CPU 114 to provide a prescribed update of the stored CED associated with the selected cloud provider based on the data received from the management server 16. If the CSA device 10 does not allow the prescribed update to be performed, for example, due to user's actions or planted malware, the cloud user may be prevented from accessing the remote computing resources of the selected cloud provider.

After updating the respective CED in the CED storage device 116 or if no update is required, the management server 16 may provide a verification acknowledgement to confirm that the respective CED meets requirements of the selected cloud provider. Only after receiving the verification acknowledgement, the network CPU 114 allows the CED of the selected cloud provider to be transferred to and run by a main CPU 128 of the CSA device 10 or an external local computer device 26. Hence, the CSA device 10 of the present disclosure allows the cloud provider to maintain full control over a local computing environment utilized by a cloud user to access computing resources of the cloud provider, to make sure that the local computing environment does not have security holes that can be used by a hacker to compromise remote computing resources of the cloud provider, and to maintain a security policy for a particular cloud user.

As discussed above, the CSA device 10 may operate autonomously to enable a cloud user to operate with remote computing resources without additional computer devices. Alternatively, the CSA device 10 may operate as an attachment to a local computer device 26. When the network CPU 114 allows the CED of a selected cloud provider to be run, the CED is transferred from the respective partition of the CED storage 116, or from the optionally provided RAM 126, via a data path including a data flow control circuit 130. Alternatively, only a hibernate file created for the selected cloud provider may be transferred. When the CSA device 10 operates in an autonomous mode, the security microcontroller 102 controls the data flow control circuit 130, to forward the CED to the main CPU 128. When the CSA device 10 operates as an attachment to the local computer device 26, the data flow control circuit 130 is controlled to forward the CED to the local computer device 26. A bus 132 is provided to drive the CED between the network CPU 114 and the data flow control circuit 130, buses 134 and 136 are arranged to transfer the CED between the data flow control circuit 130 and the main CPU 128, and buses 138 and 140 are provided for transferring data from the data flow control circuit 130 to the local computer device 26. The buses 132, 134, 138 and 140 may be any data transfer systems capable of transferring data between components of the CSA device 10 or from the CSA device 10 to the local computer device 26. The bus 138 is configured to prevent data transfer from the local computer device 26 to the CSA device 10 so as to protect resources of the CSA device 10 from contamination by malware from the local computer device 26.

Alternatively, network interface circuits may be used instead of buses to provide connection over a network, such as a local area network, between the data flow control circuit 130 and the main CPU 128 or the local computer device 26. The network interface is configured to prevent data input from the local computer device 26 to the CSA device 10.

Further, after the network CPU 114 allows the CED to be run, the security microcontroller 102 controls a keyboard/mouse switch 142 to connect the keyboard 104 and the mouse 106 to a keyboard/mouse controller 144 connected to the main CPU 128, when the CSA device 10 operates in an autonomous mode, and controls a keyboard/mouse switch 142 to connect the keyboard 104 and the mouse 106 to a keyboard/mouse controller 146 of the local computer device 26 when the local computer device 26 runs the CED. The keyboard/mouse switch 142 prevents the local computer device 26 from receiving input signals from the keyboard 104 and the mouse 106 when the CSA device 10 operates in an autonomous mode. Hence, even if keylogging malware is planted in the local computer device 26, the keylogger is not able to detect input data. Also, the keyboard/mouse switch 142 prevents the main CPU 128 from receiving any input signals from the keyboard 104 and the mouse 106 when the local computer device 26 runs the CED. Therefore, malware planted in the local computer device 26 cannot compromise data in the CSA device 10 via the input devices.

Also, the keyboard/mouse switch 142 may be controlled by the security microcontroller 102 to prevent the local computer device 26 from receiving inputs from the keyboard 104 and the mouse 106 when the security microcontroller 102 receives sensitive input data from a cloud user, for example, to perform user verification and authentication. As a result, even if a keylogger is planted in the local computer device 26, the keylogger is not able to detect sensitive information entered by the user when the user performs cloud access procedures.

In an autonomous mode of operation, the CED of a selected cloud provider are transferred to the main CPU 128. Before the main CPU 128 is allowed to receive the CED, the main CPU 128 may be cleared from any data or software resources such as an operating system or software applications. A boot ROM 148 may be used to store a booting program for loading the CED to the main CPU 128. Via a memory controller 150, the CED may be loaded to a RAM 152 provided to enable the main CPU 128 to run a secure local computing environment prescribed by the selected cloud provider for operating with remote computing resources of this provider. The prescribed secure local computing environment may include any system that provides controlled use of cloud provider-related information. For example, the prescribed secure local computing environment may involve provider-prescribed operating system that hosts provider-prescribed computing applications which are run on the CSA device 10 in a manner prescribed by the cloud provider.

Via a video controller 154, a monitor 156 may be coupled to the main CPU 156 to present information to a cloud user. A flash memory 158 may be provided for storing local software resources, such as tuning data provided to enhance and optimize cloud user's experience when the cloud user operates with remote computing resources. The flash memory 158 may be split into multiple memory partitions p1, p2, . . . , pn, each assigned to a particular cloud provider. Software resources associated with a particular cloud provider may be stored in the memory partition assigned to this provider so as to physically isolate software resources of one provider from secure resources of the other providers. As a result, the local computing environment produced for one cloud provider cannot be modified or compromised by malicious data of another provider. A memory region switch 160 may be controlled by the security microcontroller 102 to allow a memory partition for the selected cloud provider to be accessed.

In accordance with an exemplary embodiment of the disclosure, a memory partition of the flash memory 158 may store the CED of a particular cloud provider, whereas the memory partition of the CED storage device 116 may store only a hibernate file created for that cloud provider. This arrangement allows the cloud access device 10 to accelerate access to resources of a particular cloud provider.

Further, the memory partitions of the flash memory 158 may include a temporary memory partition for storing a memory snapshot file corresponding to the snapshot of the RAM 152. The memory snapshot file may be created for a particular cloud provider in order to enable the cloud user to access resources of that cloud provider while the cloud access device 10 performs operations with resources of another cloud provider.

When the main CPU 128 runs a local computing environment prescribed by the selected cloud provider, the network CPU 114 may be allowed to access remote computing resources of the selected cloud provider to enable the cloud user to operate with the remote computing resources. The management server 16 of the selected cloud provider may control a type of connection used by the network CPU 114 to access the remote computing resources over the data network 14. For example, the management server 16 may require that only a secure connection, such as Transport Layer Security (TLS) or Secure Sockets Layer (SSL) connection, must be used to access computing resources of a particular cloud provider or to access a particular resource offered by the cloud provider.

When the cloud user completes access to a particular cloud provider, the cloud user may choose to select another available cloud provider. In this case, all data and software resources used for operating with previous cloud provider are cleared from the RAM 152 and registers of the main CPU 128. Thereafter, the CSA device 10 performs access to a newly selected cloud provider by repeating the procedures described above.

In accordance with an exemplary embodiment of the disclosure, before clearing data and software resources from the RAM 152, the contents of the RAM 152 may be written as a hibernate file into the respective memory partition of the CED storage device 116 and/or the respective memory partition of the flash memory 158. As a result, when the cloud user needs access to a particular cloud provider, the RAM 152 may be quickly restored to the state that existed when the cloud user accessed this cloud provider previously.

Also, before clearing data and software resources from the RAM 152, the snapshot of the RAM 152 may be loaded into a temporary memory partition of the flash memory 158 in order to enable the cloud user to access resources of one cloud provider while the CSA device 10 operates with resources of another cloud provider.

As one skilled in the art of data processing will realize, the secure access device of the present disclosure may be implemented in a number of different ways. In particular, it may be implemented as a specifically engineered hardware device including a chip or a number of chips having data processing circuits and other components, such as a read-write memory and a read-only memory, for performing the functions described above. Alternatively, the secure access device may be implemented using a general purpose digital signal processor, appropriate memories and programming.

The foregoing description illustrates and describes aspects of the present invention. Additionally, the disclosure shows and describes only preferred embodiments, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art.

The embodiments described hereinabove are further intended to explain best modes known of practicing the invention and to enable others skilled in the art to utilize the invention in such, or other, embodiments and with the various modifications required by the particular applications or uses of the invention.

Accordingly, the description is not intended to limit the invention to the form disclosed herein. Also, it is intended that the appended claims be construed to include alternative embodiments.

What is claimed is:

1. Secure access device for providing secure access of a computing resources (CR) user to remote computing resources offered by multiple CR providers, the secure access device comprising:
a network interface for providing interface to a data network configured for accessing the remote computing resources offered by the multiple CR providers,
a network access controller configured to interact with the network interface for controlling access of the CR user to the remote computing resources,
multiple data storage sections, each data storage section being configured to keep computing environment data (CED) associated with a particular CR provider of the multiple CR providers, the CED defining a secure local computing environment prescribed by the CR provider for accessing the remote computing resources offered by the CR provider,
the network access controller being configured for enabling the CR provider to manage the CED and for preventing the CED from being modified.

2. The device of claim 1, wherein the network access controller is further configured for preventing an unauthorized party from accessing remote computing resources associated with the CR user.

3. The device of claim 2, further comprising a security controller for controlling the network controller so as to enable the CR user to access the remote computing resources and to prevent an unauthorized party from accessing the remote computing resources associated with the CR user.

4. The device of claim 3, wherein the security controller is configured to encrypt data of the CR user stored at a remote storage of a CR provider.

5. The device of claim 1, wherein the network access controller is configured to enable the CR provider to control user's access to the remote computing resources so as to allow the user's access only in a manner prescribed by the CR provider.

6. The device of claim 1, wherein the network access controller is configured to enable the CR provider to prevent a data processing unit from producing the local computing environment for access to the remote computing resources, without authorization of the CR provider.

7. The device of claim 6, wherein the network access controller is controllable by the CR provider to allow the data processing unit to run the CED so as to produce the local computing environment.

8. The device of claim 1, wherein the network access controller is controllable by the CR provider to prevent an unauthorized user of the secure access device from accessing the computing resources offered by the CR provider.

9. The device of claim 1 further comprising an internal data processing unit configured for receiving the CED to produce the prescribed local computing environment.

10. The device of claim 9, wherein the network access controller is configured to allow the CED to be transferred to the internal data processing unit only after receiving authorization from the CR provider.

11. The device of claim 9 further comprising a data flow control circuit configured for selectively transferring the CED to the internal data processing unit or to an external computer device externally coupled to the secure access device.

12. The device of claim 11, wherein the data flow control circuit is configured for preventing the external computer device from receiving the CED when the internal data processing unit is selected for producing the prescribed local computing environment.

13. The device of claim 11 further configured for preventing the secure access device from receiving an input signal from the external computer device.

14. The device of claim 11 further comprising an input device controller configured for receiving an input signal from an input device used by the CR user, the input device controller being configured for forwarding the input signal to the internal data processing unit when the CED is transferred to the internal data processing unit, and for forwarding the input signal to the external computer device when the CED is transferred to the external computer device.

15. The device of claim 14, wherein the input device controller is configured to prevent the input signal from being forwarded to the external computer device, when the CED is transferred to the internal data processing unit.

16. The device of claim 14, wherein the input device controller is configured to prevent the input signal from being forwarded to the internal data processing unit, when the CED is transferred to external computer device.

17. The device of claim 14, wherein the input device controller is configured to prevent the input signal from being forwarded to the external computer device when the CR user enters sensitive information using the input device.

18. The device of claim 1, further comprising a buffer memory configured for preloading the CED data from the data storage section while the network access controller obtains the CR provider's authorization to transfer the CED for producing the local computing environment.

19. The device of claim 1 configured for providing the CR user with secure access to cloud providers that offer cloud computing resources.

20. The device of claim 1 configured for providing the CR user with secure access to medical data stored by remote medical information providers.

21. The device of claim 1, further including an operating memory for storing data and software resources when the CR user operates with remote resources of a CR provider, wherein the CED includes a hibernate file for restoring content of the operating memory to a state that existed before the CR user terminated previous access to the resources of the CR provider.

22. The device of claim 1, further including an operating memory for storing data and software resources when the CR user operates with remote resources of a particular CR provider, wherein a snapshot of content of the operating memory is created when the CR user terminates access to resources of a first CR provider, the snapshot being stored in the device so as to enable the CR user to operate with the resources of the first CR provider while the CR user operates with resources of a second CR provider.

23. A method of enabling a CR user to access remote computing resources offered by multiple CR providers over a data network, the method comprising the steps of:
enabling multiple CR providers to manage access data in an access device available for the CR user, the access data being provided to enable the CR user to access the remote computing resources over the data network,
maintaining the access data in the access device so as to prevent the CR user from modifying the access data, and
enabling the CR user to prevent an authorized party from accessing the remote computing resources associated with the CR user.

24. The method of claim 23 further comprising the step of based on the access data, producing a local computing environment for accessing the remote computing resources.

25. The method of claim 24 further comprising the step of enabling the CR user to select between producing the local computing environment in the access device, and producing the local computing environment in an external computer device.

26. The method of claim 25 further comprising the step of preventing the external computer device from receiving an input signal from an input device when the CR user enters sensitive information using the input device.

27. The method of claim 25 further comprising the step of preventing the external computer device from receiving an input signal from an input device used by the CR user when the local computing environment is produced in the access device.

28. The method of claim 25 further comprising the step of preventing the external computer device from receiving the access data from the access device when the local computing environment is produced in the access device.
